(19) United States
(12) Patent Application Publication
(10) Pub. No.: US 2006/0111845 A1
(43) Pub. Date: May 25, 2006

(54) Method for managing agricultural produce inventories

(76) Inventors: Jonathan Michael Forbis, Greensboro, NC (US); William Grant Aldridge, Morrisville, NC (US); Daniel Shalom Hart, Centreville, DE (US); Michael Eugene Smith, Wilmington, DE (US)

Correspondence Address: SYNGENTA BIOTECHNOLOGY, INC.;PATENT DEPARTMENT, 3054 CORNWALLIS ROAD, P.O. BOX 12257, RESEARCH TRIANGLE PARK, NC, 27709-2257, US

(21) Appl. No.: 11/242,117

(22) Filed: Sep. 30, 2005

Related U.S. Application Data
(60) Provisional application No. 60/614,485, filed on Oct. 1, 2004.

(51) Int. Cl. G06F 19/00

(52) U.S. Cl. 702/19; 702/22

(57) ABSTRACT

The present invention relates to a system and method for managing and monitoring agricultural produce inventories from harvest forward in the supply chain, including obtaining data points relating to activity and activity locations that bear on the produce as it moves along the supply chain, and further includes methods for tracing inventory histories. The invention includes three component parts; (1) management of variables that impact the crop prior to the farm gate, (2) tracking, tracing, and monitoring functions for the crop as it moves through the supply chain, and finally (3) crop-specific integration of the system and it's requisite control points into a wide variety of entities within the fresh produce supply chain with minimal impact on existing operations. Also included is a system and method for assigning a non-unique identifier to the segregated crop batch or product and associating a global location identifier indicating a point of origin of said crop batch with said non-unique identifier. This association transforms the non-unique product identifier into a globally unique identifier.

### FIELD OF THE INVENTION

The present invention relates to a system and method for managing and monitoring agricultural produce inventories from harvest forward in the supply chain, including obtaining data points relating to activity and activity locations that bear on the produce as it moves along the supply chain, and further includes methods for tracing inventory histories.

### BACKGROUND OF THE INVENTION

Managing agricultural produce inventories through the supply chain is currently subject to disparate control and monitoring mechanisms. Tracing agricultural inventories is also currently difficult requiring downstream customers to access upstream processors, suppliers or other supply chain participants' unique management systems, assuming they exist. In addition, monitoring of some aspects of the agricultural produce supply chain is non-existent. The current state of the art makes it sometimes impossible to trace agricultural produce inventories, and the activities and events that bear on the produce, as the produce moves along the supply chain.

The use of barcode technology significantly reduces the number of errors associated with data capture by reducing the amount of data entry done by humans. These sources indicate that a savings of as much as 18% is possible through gained efficiencies. However, the use of the current UPCs for farm produce is problematic owing to the use of the Produce Manufacturers Association's (PMA) Uniform Council Code (UCC) Identifier by many of the produce manufacturer's. For example, a valid UPC code for Tomatoes, Cherry, Non-Canadian, 20 oz. container could be comprised of the PMA's UCC Id and the UPC item number: 0333833-65569. However, this number does not contain sufficient information to determine the country of origin, the manufacturer, any repackers, or the retailer. The present invention recognizes the need for a system and method for generating unique barcodes and managing and tracing agricultural produce inventories as such inventories move through the supply chain.

### DEFINITIONS

“Harvest zone” refers to a quantity of land under cultivation that is managed consistently in terms of production inputs during a specific planting.

“Harvest event” refers to a discreet instance in which select portions of a crop planted on a specific harvest zone is removed for processing

“Processing event” refers to any discreet event that occurs in a processing facility that serves to alter the state of a processing lot. Examples would include gassing durations, storage temperature, product reconfiguration, etc.

“Load ID” refers to the numerical identifier assigned to a discrete truck-load (or other transport load mechanism) of product at a point in time during a harvest event. This information is indexed as a fully qualified Global Trade Item Number (GTIN) as EAN/UCC-14+GLN+Lot Number within the QMS data warehouse.

“Data warehouse” refers to an internet-based, data repository that contains production information a grower can choose to make available to downstream customers.

“Local data store” refers to a database local to the user's internal computer network that contains QMS information. This database serves as the integration point for system integration with other 3^{rd} party information systems and stores information that is eventually published to the data warehouse.

“Control point” refers to a process or product check used to monitor or isolate variables that affect crop attributes.

“Processing batch” refers to a quantity of product that is processed at a point in time and delineated by a single processing ID number. This quantity of product can originate from one or more harvest zones.

“Processing ID” refers to a fully qualified (GTIN) Global Trade Item Number (as EAN/UCC-14+GLN+Lot Number) that uniquely identifies a single processing batch.

“PLU code” is a price look UP code. Used for single, loose or bulk items. 4 digit code with the manufacturing prefix of 033383 indicates fresh produce. Example: 4805=Global, non Canadian, small vine ripe tomatoes.

“UPC code” is a code issued to indicate type of farm produce, for example, a tomato. It is used for packaged items in either discreet units or case amounts. This can be UCC 12, 13, 14 or 128. It is not generally cross referenced with the PLU Code. Example: 65569=Cherry Tomatoes, Non Canadian, in 20 oz container.

“Case” refers to the primary level of packaging used in ordering, shipping, and billing.

“Shrink” refers to a product that is lost due to deterioration prior to being sold.

“Check-in” refers to the process of associating a lot of produce back to its originating unit of measure after it has been configured within the supply chain.

### BRIEF DESCRIPTION OF THE DRAWINGS

FIG. 1 shows flow and block diagrams of an embodiment of the Quality Management System of the invention.

FIG. 3 is a block diagram depicting an embodiment of an information implementation system of the invention.

FIG. 6 is a flow chart illustrating the sequence of operating steps that can be implemented during Harvest Data Entry and Harvest Data Synchronization.

FIG. 7 is a flow chart illustrating the sequence of operating steps that are implemented for receiving of farm product at the Receiving or Processing Facility

FIG. 8 is a flow chart illustrating the sequence of data entry steps associated with farm product located at the processing facility.

FIG. 9 is a flow chart illustrating the sequence of steps for batch labeling.

FIG. 10 is a flow diagram illustrating the sequence of steps for shipping of batch products.

FIG. 11 is a flow diagram illustrating the retail trace back process.

FIG. 12 is a flow diagram illustrating retail packaging labeling.

FIG. 13.1-13.4 shows menu screens illustrating steps for entry of harvest information of a harvest event.

FIG. 14 is a schematic showing the receiving module window.

FIGS. 14.1-14.3 are schematics showing the QMS software modules.

FIG. 15 is a schematic showing the packing module window.

FIG. 16 is a schematic showing the shipping module window.

FIG. 17 is a schematic showing the labels module window.

FIG. 18 is a schematic showing the reports module window.

FIG. 19 shows a copy of a field ticket.

FIG. 20 is a schematic showing the setup module window.

FIG. 20.4 is a schematic showing the manager user security module window.

FIG. 20.5 is a schematic showing the current grades module window.

### DETAILED DESCRIPTION OF THE INVENTION

The present invention includes what is referred to herein as the Quality Management System (QMS). The present invention allows users within the fresh farm produce industry to monitor all critical production and post-harvest factors that can positively or negatively impact a desired downstream product trait through delivery to the retail or foodservice customer. The QMS includes three component parts; (1) management of variables that impact the crop prior to the farm gate, (2) tracking, tracing, and monitoring functions for the crop as it moves through the supply chain, and finally (3) crop-specific integration of the system and it's requisite control points into a wide variety of entities within the fresh produce supply chain with minimal impact on existing operations.

The present invention includes the tracking of production inputs, application intervals, and harvest timings and associating that information to a specific geo-referenced unit of land management. According to the present invention, this information is associated with that segregated crop “batch” as it leaves the farm-gate and travels with that batch as it moves through the supply chain where it may or may not be re-configured into other units of measure.

The present invention further includes assigning a non-unique identifier to the segregated crop batch or product and associating a global location identifier indicating a point of origin of said crop batch with said non-unique identifier. This association transforms the non-unique product identifier into a globally unique identifier.

According to the invention, the globally unique identifier is downloaded to a ware house database. The present invention also includes printing the globally unique identifier to a label that is then associated with the corresponding crop batch, wherein the crop batch can be in any number of configurations, including bulk or in various packaging options.

The invention includes labeling a batch of product using a UCC/EAN compliant CODE-128 barcode that serves as a globally unique “passport” based on product identification, global location, and lot. The system and method of the present invention provides this unique ID thereby providing ancillary information, such as variables that impact the crop prior to the farm gate, transit temperature during shipping, time in gas, pack date, EDI information, etc. to be associated with the passport for that particular batch of product. The present invention uses FMS software of AgConnectioins, Inc to manage pre-farm-gate variables that impact a crop.

The FMS is an agronomic record-keeping tool that associates production inputs (water, chemical applications, plastic, labor, etc.) back to a specific harvest zone during a specific planting. Harvest zones are identified relative to their corresponding Farm and Field parent superstructures and defined in terms of Geographic Information System latitude and longitude values. The present invention includes a system and method that associates information recorded in the FMS system with the QMS capability of tracking a batch of fresh produce through its entire supply chain, thereby allowing crop production history to be referenced by downstream crop customers. Pre-farm-gate activities managed include, establishing separate harvest zones that allow a grower to harvest quantities that allow for peak efficiency at the packing shed. The size of the harvest zones are artificial and vary from organization and perhaps by location within an organization. Harvest zones are field mapped for reference using standard GIS conventions. Information that is preserved for later reference can include: field center latitude and longitude coordinates, field acres, grower, farm, field, crop, sub-crop, unique field identifier, planting date/transplanting, individual actual records including (variety—seed, fertility, crop protection, services, surfactants, transplant), product, rate, date, harvest (multiple harvests), date of harvest, and picking methods, product labeling information, field re-entry intervals, field posting related information, and working handling information. A PDA is often used to accommodate the marking of input “actuals” by the farm manager while in the field. This function allows for in-field harvest actuals.

The FMS associates field tickets and transfer tickets with a particular harvest zone via a combination scanning/data entry function. This function is referred to as the harvest module and also allows for the monitoring of actual yield for that particular harvest zone.

The FMS harvest module associates, for example, cases of clamshells (typically a case equals 304 or 336 clamshells) to an individual harvest zone. A hand-held scanner can be utilized to scan a 24 digit number stored in a code 128 symbology format. The first 12 numbers indicates the first number of the range and the second 12 digits constitutes the end of the range.

The FMS includes a field traceability report that shows a summary of the history of a particular harvest zone by individual harvest zone, farm, and operation. FMS can accommodate factors unique to any particular farm production.

The system and method of the present invention utilizes pre-farm-gate information and activities captured by FMS, by providing a system and method for downloading such information and activities to the warehouse database of the invention.

The present invention uses barcode symbology that is readable by existing or industry-standard equipment throughout the chain.

The present invention further includes a system and method that does not require stringent adherence to a particular chronological flow allowing for deployment of the present invention into “real world” packing scenarios.

The present invention further provides for managing and tracing produce inventory from a single system of record and further provides normalizing historical quality data across the partner network.

The present invention also provides a system and method for preserving the quality and production history of produce inventory in a standardized format for analysis across the entire system (by crop or geography).

The present invention also provides a system and method is easily integrated with existing systems and supports emerging technologies such as FRID/RSS bar-coding.

The present invention also provides a system and method further provides a PMA (UCC/EAN) and COOL/Bio-Terrorism complaint reporting and labeling solution.

The present invention further reduces produce shrink through total quality management of the variable that impact the produce as it travels through the supply chain.

The present invention also includes incorporating geo-referenced tracking to monitor agronomic variables introduced by problems in adjacent growing areas.

The QMS also includes a method of providing a reporting interface to third parties that allows such parties to monitor relevant historical information and access profiled user accounts.

According to the system and method of the present invention, product labeled as UCC/EAN compliant GTIN formatted as code 128 barcode GTIN changes as product configuration changes in the supply chain. GTIN product configurations are granular to the level of specific product attributes. For example, a GTIN formatted code can define product attributes, such as tomato, round, FL47 (4×4) single-layer; tomato, round, Sebring (5×6) double-layer.

In one embodiment of the invention the agronomic history of a batch of tomatoes, for example, is preserved at the grower/shipper by a number printed on a label applied to a 25 lb.box. A label is applied to consumer tomato configurations at the repacker. This repacker traceability label is separate from the branding label and UPC. In one embodiment, the repacker traceability label is applied to the bottom or side of a container in order to not confuse POS checkout.

In another embodiment of the QMS identify preservation system and method of the invention, the agronomic history of an individual clamshell of strawberries, for example, is preserved by associating a “range” of clamshells back to the harvest zone from which they originated via a check-in process that occurs before a case of clamshells is deployed to a picking crew for use in a harvest operation.

The agronomic history of a unit of produce can be referenced online via a secure web page. The history is available upon entering a valid production ID as displayed on the product. All partner data is profiled and secured so that only parties requiring access to that partner's data will be able to view the information.

The reporting system of the invention allows for an internal auditing function as well. This function can check agronomic inputs against an agronomic protocol associated with a particular production batch, as information is made available to the data warehouse of the invention. In one embodiment, indication of compliance is displayed on the same screen that displays the agronomic history of the production batch. An automated daily report is sent via e-mail that indicates production batches outside the control limits of the agronomic protocol. The internal auditing function runs on the total population of products that pass through the QMS.

The system and method of the present invention allows for an external auditing function that interfaces with external audit entities in order to conduct sampled audits of a particular produce production. In one embodiment, the interface is internet-based.

The warehouse database is capable of filtering grower data so that only acres that are committed to the QMS are stored to the database. Data transfer from the warehouse database is via a secure transport mechanism.

The present invention also provides for tracing of bulk product from the flat-level back to its geo-referenced point of origin and of inner-wrap product back to its geo-referenced point of origin.

The present invention further includes obtaining a history of production agronomic inputs linked to the geo-referenced point of origin for a particular batch of product. Trace history includes Food Safety audit and certification criteria for GAP, GMP, HAACP

Bar coding requirements are based on two publications: PMA Pallet and Case Coding, PMA Best Practices, December 2002; EFR Supply Chain Demand Forecasting Committee and Uniform Code Council, Inc. Standard Identification and Bar Codes: The Cornerstone of EFR.

Additionally, the standards for the Fresh Vision Bar Code are also reflective of meetings and conversations held with Greg Rowe, Director, Food & Beverage, Uniform Code Council as well as Gary Flemming, author of the EFR Standard, PMA's Case Coding and Handling Best Practices, and chief architect of the PMA's IPD standard.

It is preferred that the barcode symbology of the present invention be readable by existing or industry-standard equipment throughout the chain.

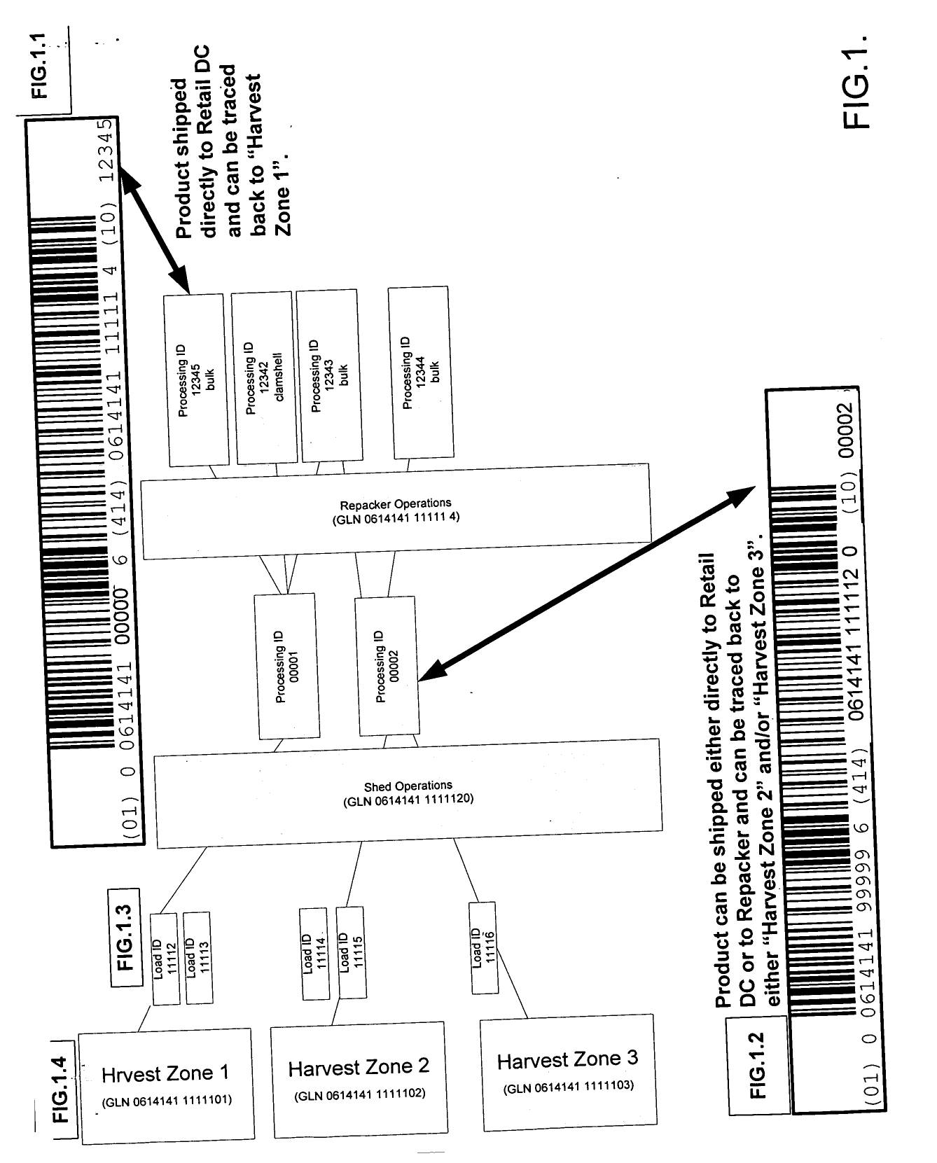

Referring to FIG. 1.2:
(01) GTIN number follows
0 packaging type indicator
0614141 UCC Company Prefix
999999 Fresh Vision Item Number (6-Digit internal product ID as defined within SAP, first 4 digits: variety, last 2 digits are reserved)
6 Check Sum to determine that the prior digits are correct
(414) GLN number follows leading zero
0614141 SYT UCC Company ID
111112 Shed location number (first two digits reserved, next three digits: site location number)
0 Check Sum to determine that the prior digits are correct
(10) Lot Number follows
00002 FCMS assigned Lot Number

### EXAMPLE I

### Harvesting to First Processor Operation

Picking crews pick a crop from a specific harvest zone into logistical units of measure such as bins, gondolas, or wagons. When the desired shipping quantity is achieved and the load is ready to be transported to a first processor operation, such as a shed, for processing, the picking crew leader or farm manager completes one of the following options.

OPTION A: A crew leader, for example, fills out traditional multi-form “field ticket” and scans the random 6 digit number in order to “check-in” the load to the QMS Harvest Module. (Note: If this option is used, the process can be used in a “batch” process in which the loads can be “checked-in” after the actual shipping event.

OPTION B: A crew leader, for example, “Checks-In” the load to PDA based QMS Harvest Module without a traditional field ticket. The system auto-generates a random six digit tracking number and prints two copies of the check-in record to serve as hauling receipt and shed receiving receipt.

Information captured with either option includes:
Farm
Field
Harvest Zone
ProductID
Unit of Measure
No. of Units in shipment
Geo-Referenced Coordinates
Date-Time Stamp

With either check-in option above, the random six-digit number is associated with the Product ID and GLN for the harvest zone in question to comprise a UCC/EAN compliant GTIN that is unique for that event.

When each load from a particular harvest zone that is being picked arrives, the shed receiving receipt or traditional field ticket is used for the shed “check-in” process. According to the present invention, the 6 digit control number from one of the above artifacts is captured via scanning in either the wireless PDA receiving module or the terminal based receiving module within QMS. The following information is entered manually:
Product ID
Unit of Measure
No. of Units in shipment
Date-Time Stamp

According to the present invention, during the shed check-in process, the random six-digit number is then associated with the Product ID for the load being received and the GLN of the Packing facility that is receiving the product to comprise a UCC/EAN compliant GTIN that is unique for that event.

The random, 6 digit number, serves as a temporary logical bridge for the association from field to shed and is made globally unique AND permanent when it is associated to specific time/location/product information captured at the harvest and receiving “check-in” events. The load is operationally staged according to its harvest zone to wait for processing/packing.

When it is time to pack the product, 1 to many harvest zones are selected to include in the 1 to many new products to be configured. Using the packing module of the QMS system of the invention, the operation can choose to label resulting output configuration containers with the UCC/EAN Code 128 GTIN in either a batch-mode or near-real-time mode. Depending upon which method is used, an instance of the Code 128 GTIN that has been previously printed (batch approach) is scanned or a Code 128 GTIN is generated from within the packing module which feeds near-real-time print+apply printers on the packing line.

In accordance with the present invention and for each approach, the GTIN is selected from one or many previously received lot(s) and associates that information to a new GTIN (and associated Code 128 label mentioned above) based on:
Configuration (Product)
Packing Facility GLN
Date-Time Stamp
Grade (optional descriptor)
Development Stage (optional descriptor)
Storage Location

If the is a standing order for the product being packed, a portion of the lot being made can be allocated to that specific customer PO, otherwise the load is identified as a “house load.”

When it is time to ship the product, 1 to many lots is selected to be included in the shipment. These lots are associated with a pre-defined customer GLN. Data associated with a shipment includes:
Configuration (Product)
Quantity
Date-Time Stamp
Customer Shipping No. (optional)
PO (optional)

In addition, optional critical control points can be associated to the shipment. If the operation chooses to track temperature in transit, temperature sensors can be initialized directly from within the shipping module.

When a load from a customer that uses QMS arrives, the lot number from one of the cases from each pallet is scanned using either the wireless PDA receiving module or the terminal based receiving module within QMS. The following information is captured:
Supplier GLN
Unit of Measure
No. of Units in Shipment
Date-Time Stamp
Optional Reference Number

If the supplying customer has sent temperature sensors with the load, the receiving supervisor can download the transit temperature history into the QMS system from within the receiving module. The load is operationally staged according to its harvest zone to wait processing/packaging.

When it is time to pack the product, 1 to many lots is selected to include in the 1 to many new products to be configured. Using the packing module of the QMS system, the operation can choose to label resulting output configuration containers with the UCC/EAN Code 128 GTIN in either a batch-mode or near-real-time mode. Currently, the full Code 128 GTIN is printed for cases and flats (outer wrap configurations) and the GLN+Lot A1 is printed out for inner-wrap or consumer configurations such as clamshells, 3-pak overwraps, etc. Depending upon which method of the invention is used, an instance of the Code 128 GTIN that has been previously printed (batch approach) is scanned or the Code 128 GTIN is generated from within the packing module which feeds near-real-time print+apply printers on the packing line.

For either approach, the GTIN is selected from one or many previously received lot(s) and associates that information to a new GTIN (and associated Code 128 label mentioned above) based on:
Configuration (Product)
Packing Facility GLN
Date-Time Stamp
Grade (optional descriptor)
Development Stage (optional descriptor)
Storage Location

If there is a standing order for the product being packed, a portion of the lot being made can be allocated to that specific customer PO, otherwise the load is identified as “house load.”

When it is time to ship the product, 1 to many lots is selected to be included in the shipment. These lots are associated with a pre-defined customer GLN. Data associated with a shipment includes:
Configuration (Product)
Quantity
Date-Time Stamp
Customer Shipping No. (optional)
PO (optional)

In addition, optional critical control points can be associated to the shipment.

If the operation chooses to track temperature in transit, temperature sensors can be initialized directly from within the shipping module.

### EXAMPLE II

### Tomato Supply Chain Events

It is recognized that the below described system and method is applicable to fresh produce other than tomatoes.

Bulk Traceability Labeling Specification:

By way of example only, the present invention includes a method for managing tomato bulk product inventory. A tomato bulk product is labeled using a combination of the case codes (described above) as well as 5-digit PLUs defined by the retail partner. Single-layer flats containing bulk-packed product features a case code layer. Individual fruit will be labeled with a 5 digit PLU that will drive POS transactions without necessitating application for a PMA defined 4-digit PLU. The 5-digit PLU allocated by one retail partner will not necessarily be the same 5-digit number being used by a second retail partner.

Tomato Fixed Weight Package Traceability Labeling Specification:

In one embodiment, tomato bulk product is configured for sale in 1-pound clamshells, the present invention utilizes a custom UPC number with a Fresh Vision-specific item number that will allow differentiation at retail POS. In addition, each clamshell will include a non bar coded traceability label affixed to the bottom of the container either immediately adjacent to the UPC number or as a separate sticker if that product's UPC number is included in the marketing label affixed to the top of the container.

Tomato Shed Event Definitions:

In another embodiment of the invention, entities for the data warehouse are the names and locations of participating partners. Events are defined as individual tasks or data capture points, which must occur in a particular entity's location. For example a receipt of tomatoes from the farm is a singular event. Listed below by way of example only are definitions of particular events of the tomato shed processing.

| Event | Description |
|---|---|
| S_{FT} | Shed Field Ticket Receipt (Shipment from farm) |
| P_{OL} | Pack out Labeling. This is the creation of labels for the |
| | tomato cases. The label contains the GTIN + GLN + Shed |
| | Lot Number (This is unique to the participating shed). |
| | This event can occur before or after packing. This does |
| | not involve scanning. |
| S_{FTQCL} | Scanning of the of a field ticket for the particular pack |
| | out (run) + quantity (pack out) + Case label (P_{OL}) = |
| | Unique lot number. This scanning occurs to associate case |
| | codes and labels with the unique lot number in the data |
| | warehouse. |
| S_{BOL} | Bill of Lading. This is a document, which includes one or |
| | many P_{OL} and the associated amount of product being shipped |
| | to a particular entity. |
| S_{TS} | Shed Temperature Sensor. Includes a barcode temperature |
| | sensor and a single label for the pack out (P_{OL}) |

The cases, which are to be packed in the shed, include a label that maintains data concepts as expressed in the case coding specifications document. This will include a GTIN+GLN+Lot Number that will help to maintain global uniqueness in the data warehouse. The GLN is comprised of a pre-determined UCC and pre-determined location code. This location code is recorded in the data warehouse and assigned to the location at the time of system deployment.

Tomato Shed Event Data Flow:

Once the product arrives from the farm, it will be run (packed) at the shed into cases. Cases can be hand labeled from stickers providing traceability information. Within the shed several data points are captured. These data points include: arriving field ticket from the farm/grower (scanned for barcode id and quantity), total pack out of tomatoes into cases (includes the lot number and quantity), shipment of product from shed to repacker, including lot number and quantity shipped, shipment of temperature sensor from shed to repacker.

The arriving field tickets are scanned by a scanner and then uploaded to the data warehouse where they are associated with agronomic data and a lot number. Included in this association are an optional grower lot number and a required field ticket ID.

At any point, agronomic data is available for a specific field ticket and available to be viewed from within the data warehouse. This includes, but is not limited to the agronomic data from the farm, before the shipment arrives at the shed.

The printing application can include the following features: printing of a user determined amount of labels, entering and editing/updating a site specific GLN code, auto-incrementing of lot numbers, and printing additional labels after the lot has been run. The printing application of the invention may be based upon user selection or from scanned input of a handheld device.

After the pack out concludes, the full count of cases available is entered into the system, either by an interface at the data warehouse, a hand held scanner, or other device. Shipments of product occur after packing and will not necessarily include the entire load. Hence, shipping (packing slips) are sent with the load which includes quantity, and optionally a lot number, and a copy of the case label as a manifest. This event marks the end of the shed process and indicates a shipment to a repacker, or multiple repackers.

Additionally, temperature sensors, which are bar coded, are scanned and associated with a case label to be shipped with the lot. Data from the temperature sensors are input into the data warehouse and associated with respective case labels.

The data flow for events that will occur at the processing shed are as follows:
S_{FT}—Scan the field ticket, which represents the shipment from the farm.
P_{OL}—Print labels for cases, which are being or are about to be packed.
S_{FTQCL}—Scan a case label, scan a field ticket, and enter the quantity of the pack out.
S_{BOL}—Create a packing slip and enter the count for the shipment of product.
S_{TS}—Select a temperature sensor from a pool and ship with product. Affix with P_{OL}
   Repacker Event Definitions:

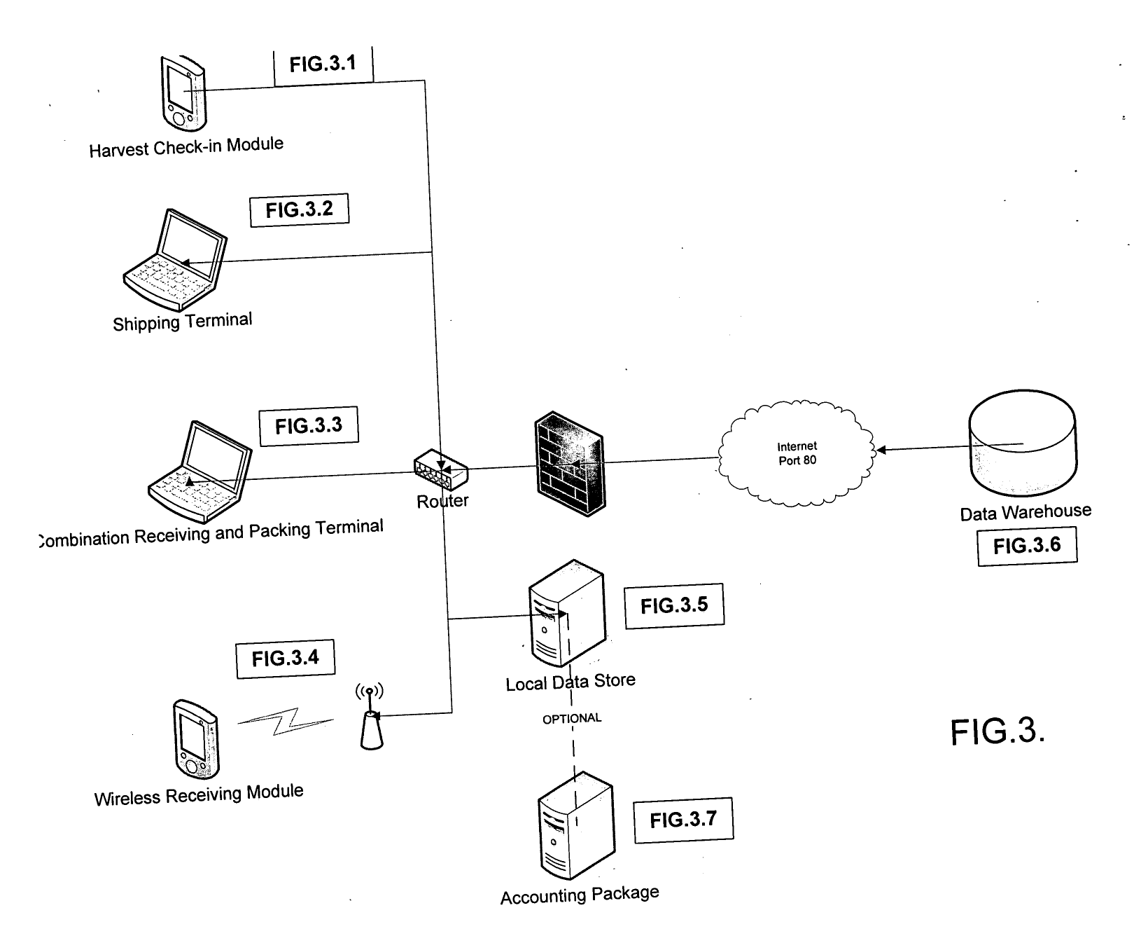

Entities for the data warehouse (FIG. 3.6) are the names and locations of participating partners. Events are defined as individual tasks or data capture points, which must occur in a particular entity's location. For example a receipt of tomatoes from the farm is a singular event. Listed below are definitions of particular events for tomato repacking.

| Event | Description |
|---|---|
| R_{R} | Repacker load and packing slip receipt (Shipment from Shed) |
| R_{TSS} | Receive temperature sensor included in load from the Shed |
| | and download temperature data in to data warehouse |
| | (FIG. 3.6). |
| R_{C} | Repacker chooses packing configuration (1# Clamshell or |
| | Single Layer Flats) for either rounds or romas'. |
| R_{PL} | Repacker prints the label appropriate for the configuration. |
| | Flats receive the same label as tomato cases in the shed. |
| | GTIN + GLN + Lot Number. Clamshells receive a unique ID |
| | to be placed on the bottom of the clam shell |
| R_{SQ} | After packing into proper configuration, repacker scans the |
| | label and the quantity |

The clamshells and flats, which are packed at the repacker, include a label that maintains data concepts as expressed in a case coding specifications document. The flats include a label, which matches the same specification of cases. This will include a GTIN+GLN+Lot Number that will help to maintain global uniqueness in the data warehouse. The GLN is comprised of a pre-determined UCC and pre-determined location code. This location code is recorded in the data warehouse (FIG. 3.6) and assigned to the location at the time of system deployment. Clamshells receive a unique ID, predetermined and leased to the specific facility placement on the underside of the package.

Repacker Event Data Flow:

At the repacker, the shipping document from the shed, included with the arriving lot, are scanned by the hand held scanner and then uploaded to the data warehouse where they are associated with agronomic data and a lot number. At any point, agronomic data must be available for a specific field ticket and available to be viewed from within the data warehouse. This includes, but is not limited to the agronomic data from the farm, before the shipment arrives at the repacker. Data from temperature sensors are uploaded to the data warehouse (FIG. 3.6).

The next event occurs at the repacker, which is printing of case labels for single layer flats. In one embodiment, flats are hand labeled from stickers providing traceability information. The flats have unique GLN's and lot number distinct from the arriving cases filling the flats.

The printing application include the following features: ability to print a user determined amount of labels, ability to enter and edit/update a site specific GLN code, ability to print additional labels after the lot has been run. This may be based upon user selection or from scanned input from a handheld device.

After the pack out concludes, the full count of cases available is entered into the system, either by an interface at the data warehouse, a hand held scanner, or other device. Shipments of product occur after packing and will not necessarily include the entire load. Hence, shipping (packing slips) is sent with the load which includes quantity, lot number, and a copy of the case label as a manifest. This event will mark the end of the shed process and indicate a shipment to a repacker, or multiple repackers.

Additionally and by way of example, product may be packed into clamshells. Clamshells will receive a human readable ID that represents the lot number and location of the product. The human readable will follow the same specification for the printer application as above with the exception of not having a bar code. The data flow for events at the repacker include:
R_{FT} Receive load from shed and scan the packing slip
R_{TSS} Retrieve the temperature sensor from load and download data to the data warehouse.
R_{C} Repacker determines configuration to be packed.
R_{PL} Repacker prints labels appropriate to the configuration
R_{SQ} After packing, a label is scanned and quantity is entered into the system.

### EXAMPLE III

### Strawberry Fixed Weight Package Traceability Labeling Specification

The present invention also includes a method or managing the strawberry product inventory. For example, strawberry inventory can be configured for sale in 1-pound clamshells. Such inventory utilizes a custom UPC number with a specific item number that will allow differentiation at retail POS. In addition, each clamshell will include a 24 digit, non-bar coded traceability label affixed to the bottom of the container located on the same sticker as the UPC immediately beneath the human-readable portion of said UPC. This 24 digit will indicate the “range” of clamshells that were originally in a discreet carton that was associated to a specific harvest zone.

### EXAMPLE IV

### General setup and System Integration of the QMS System and Method of the Invention

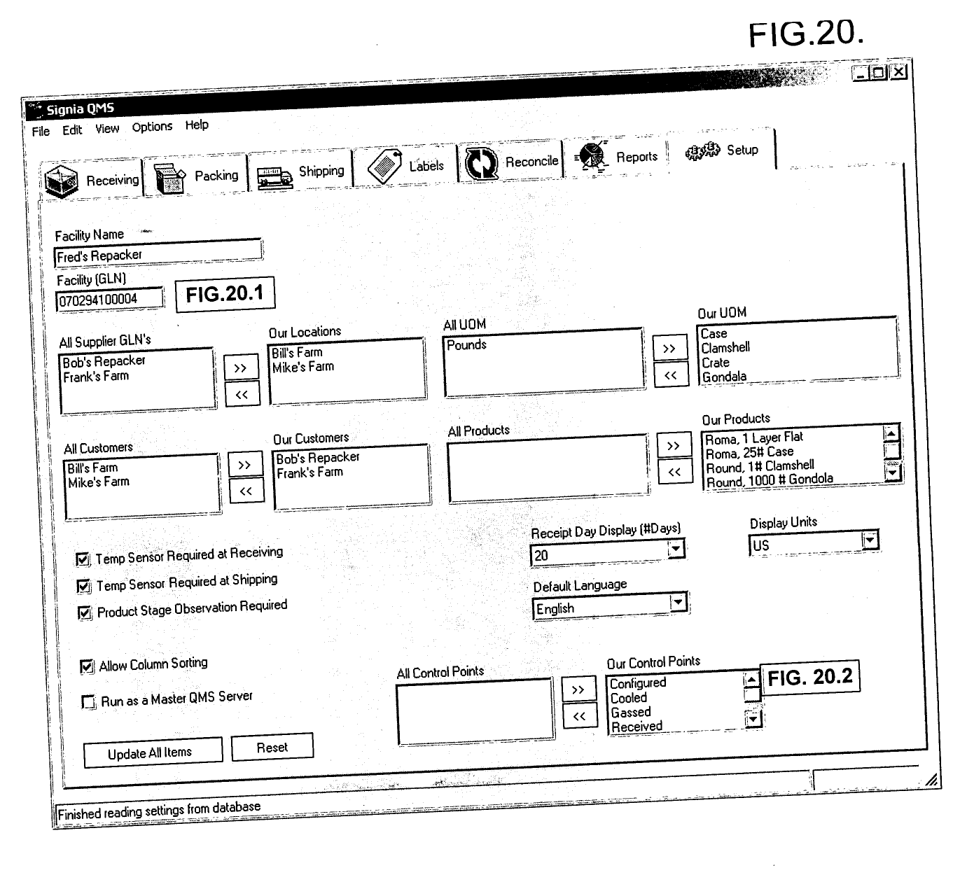

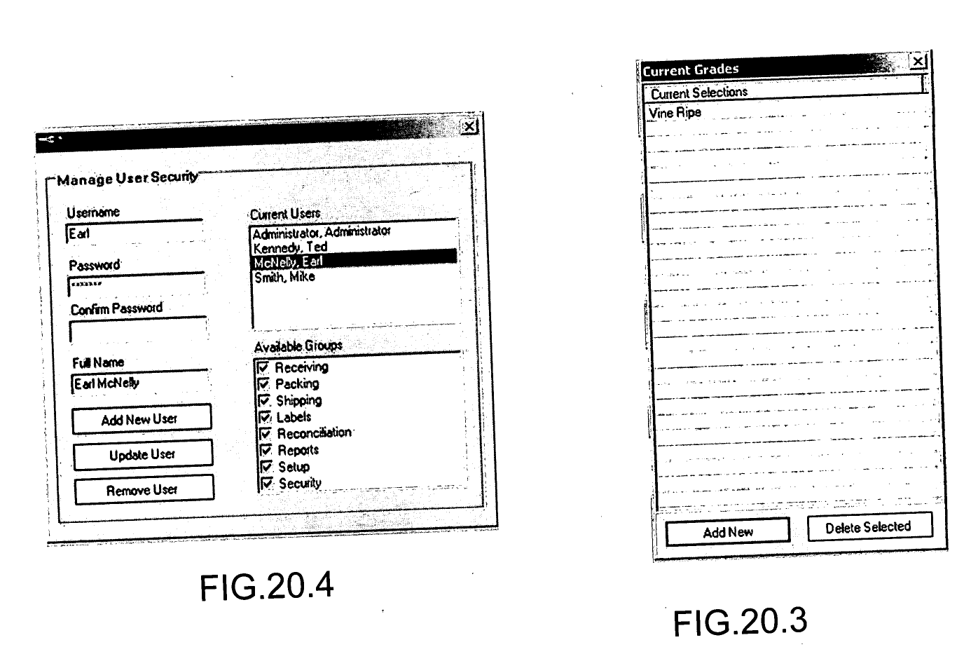

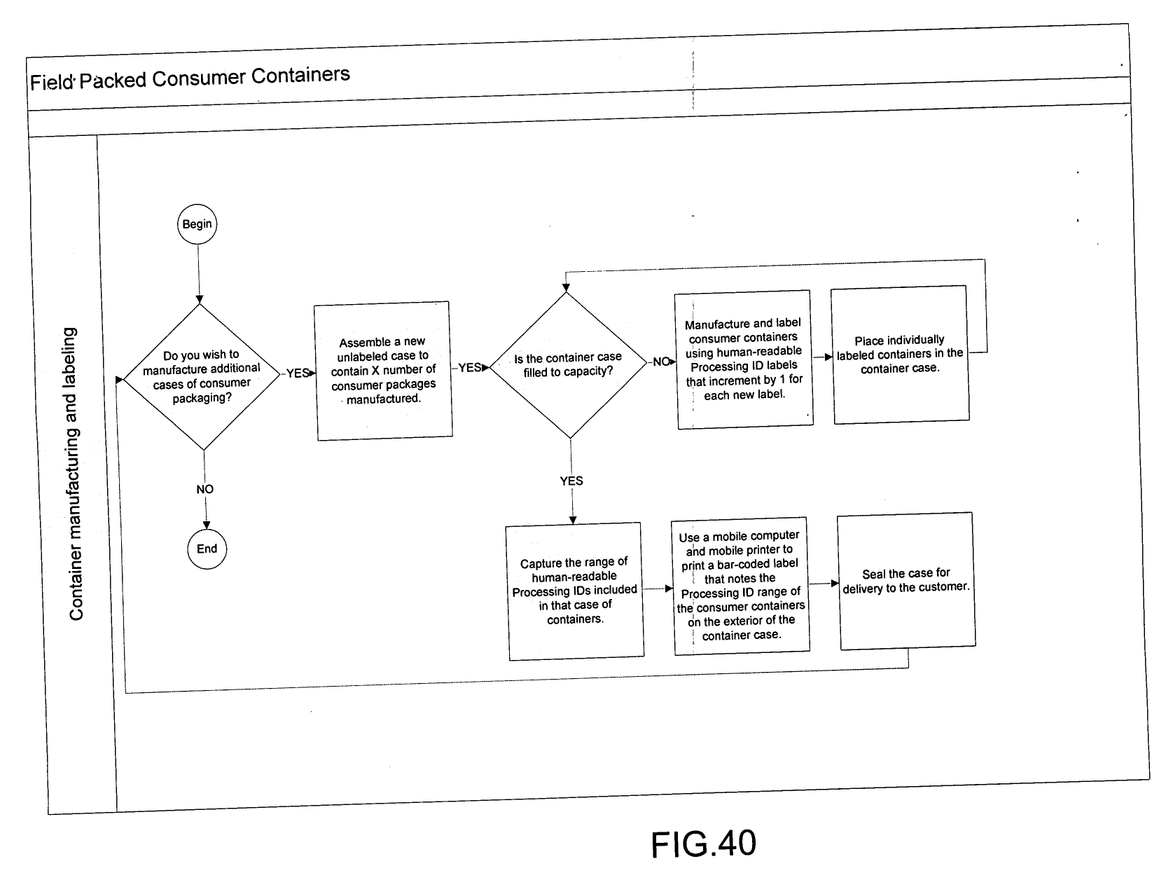

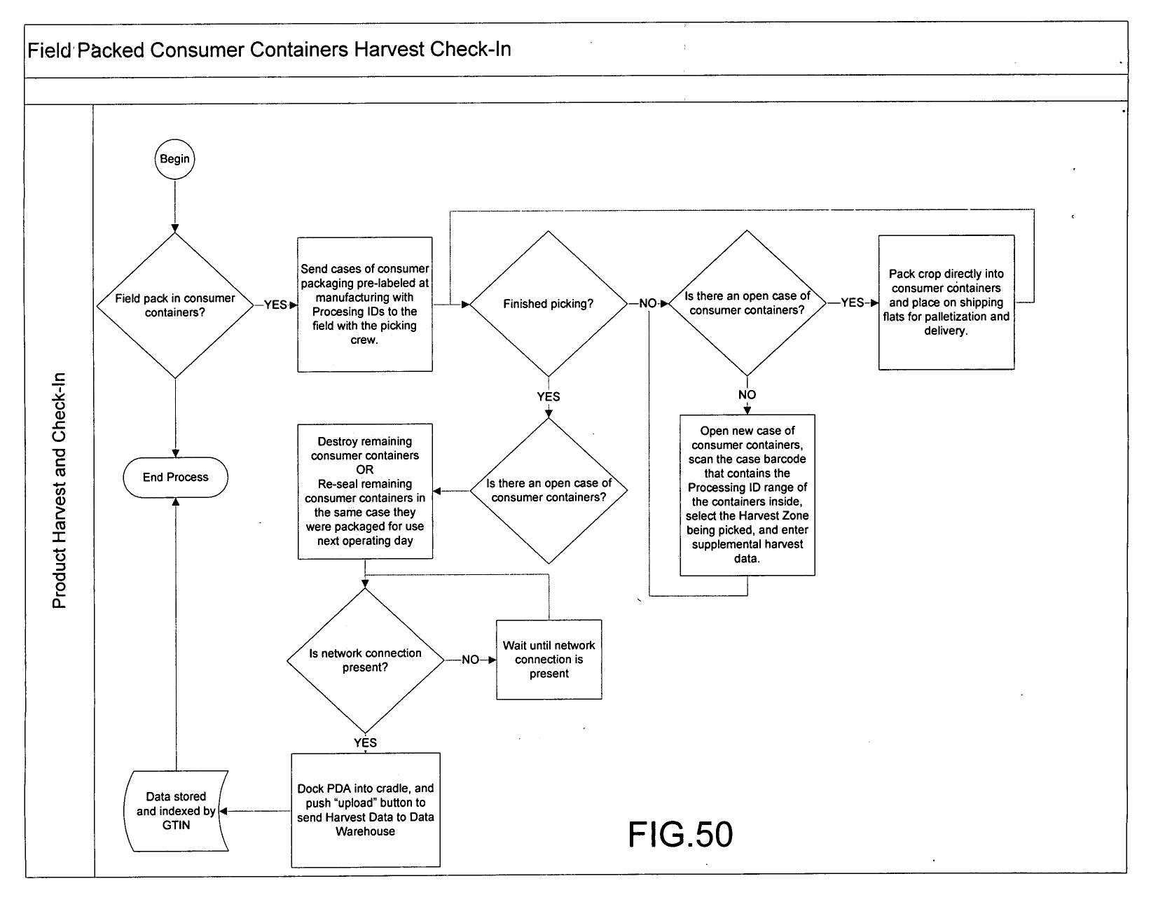

The recorded information related to pre-farm-gate activities can be associated with QMS tracking capabilities to allow crop production history to be referenced by downstream crop customers. To setup and configure the system, the user of the invention such as a grower/farmer, repacker, or shipper, first enters a facility name and is assigned a Global Location Number (GLN) that uniquely identifies that facility globally in terms of Geographic Information System latitude and longitude values (FIG. 20.1). (This information is combined during a check-in event with the Product ID and either a Load ID or Processing ID to formulate a GTIN identifier that uniquely identifies that product globally (FIG. 1). Additionally, the system administrator will select the Supplying Locations, Shipping Locations, Units of Measure, Customers, and Products that are relevant to that facility. In doing this, choices irrelevant to that location are eliminated reducing the chance for user confusion and streamlining the data entry process steps as described later.

The system administrator is also presented with options around the insertion of Control Points (FIG. 20.2) that are relevant to the process or location under consideration as well as other global system options around system reporting, language selection, and a standard vs. metric unit selection option. Finally, the user can also define product names and grades as a function of location setup via the “Current Grades” definition (FIG. 20.3).

User accounts are defined according to the invention via the “Manage User Security” function (FIG. 20.4). Once a user account has been created, it is assigned rights and permissions through the assigning of the account to “Groups”. This allows the system administrator to limit the accessibility to functions not relevant to a particular system user, minimizing unintended system access and user confusion while streamlining the operational function of using the system. For example, one user may only be able to see the Receiving tab at login, whereas users with more wide-ranging responsibility can be given access to all system functionality. The administrator can also over-ride the global language selection on an individual account basis.

Harvest event or processing event data uploaded to the data warehouse can be made available on an as-needed basis to downstream data consumers or other 3^{rd} party systems that rely on said data (FIG. 3.7). Additionally, information maintained in the Local Data Store of a particular implementation instance is fully accessible and can update other systems as is appropriate using industry standard data access methodologies.

### EXAMPLE V

### Shed Packed and Labeled Product Direct from the Field Capturing Harvest Data

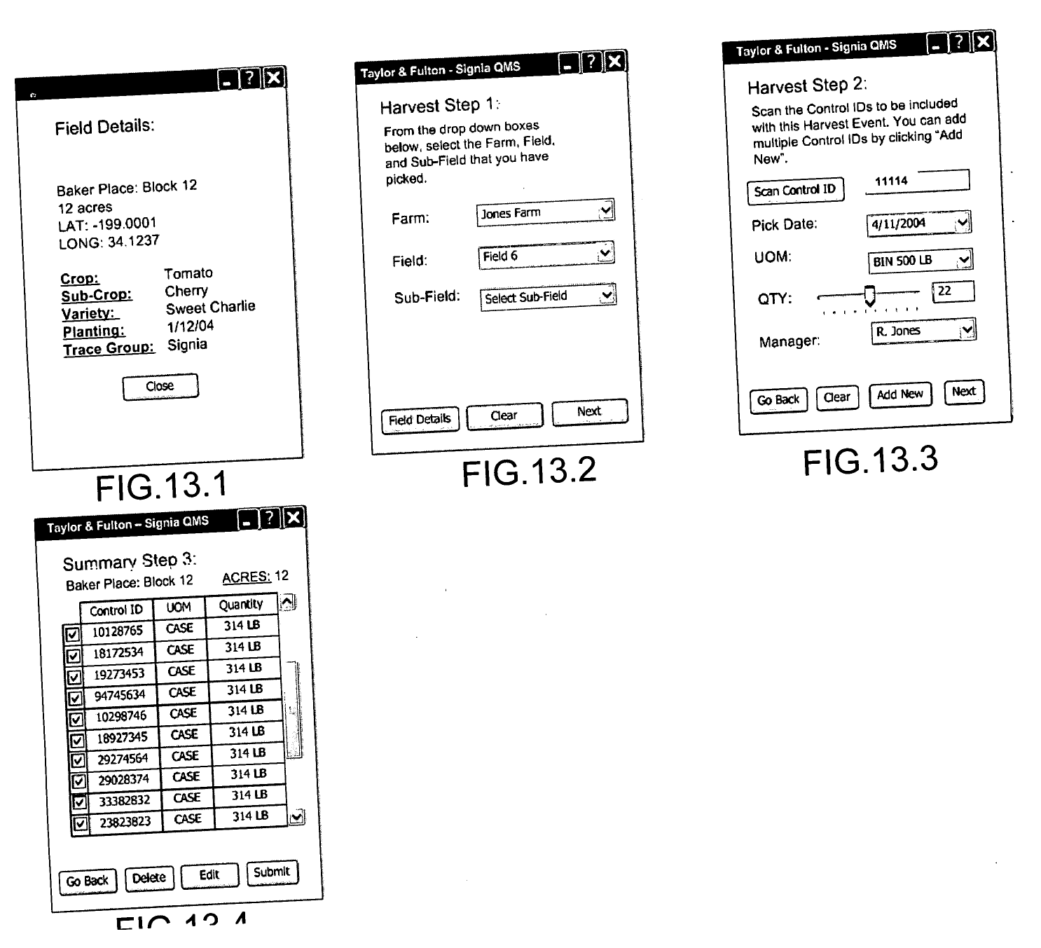

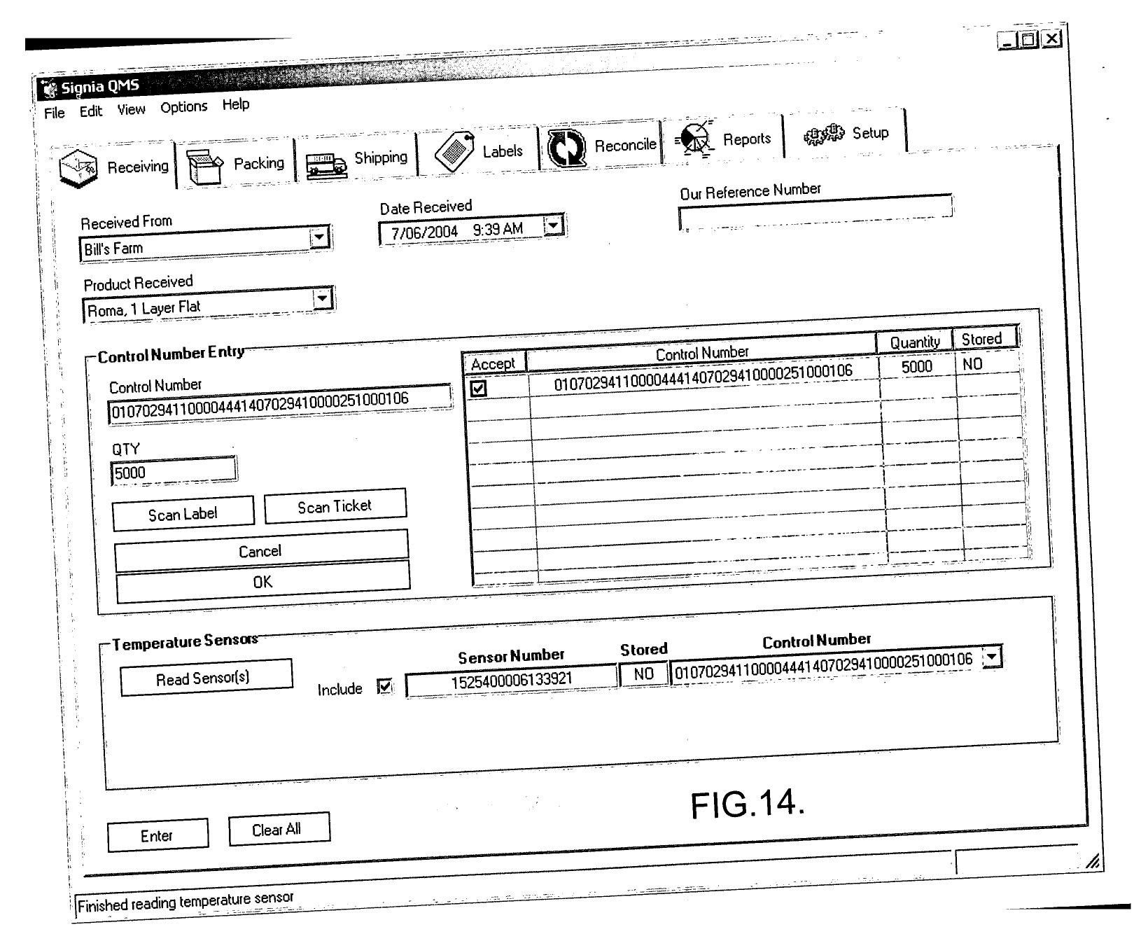

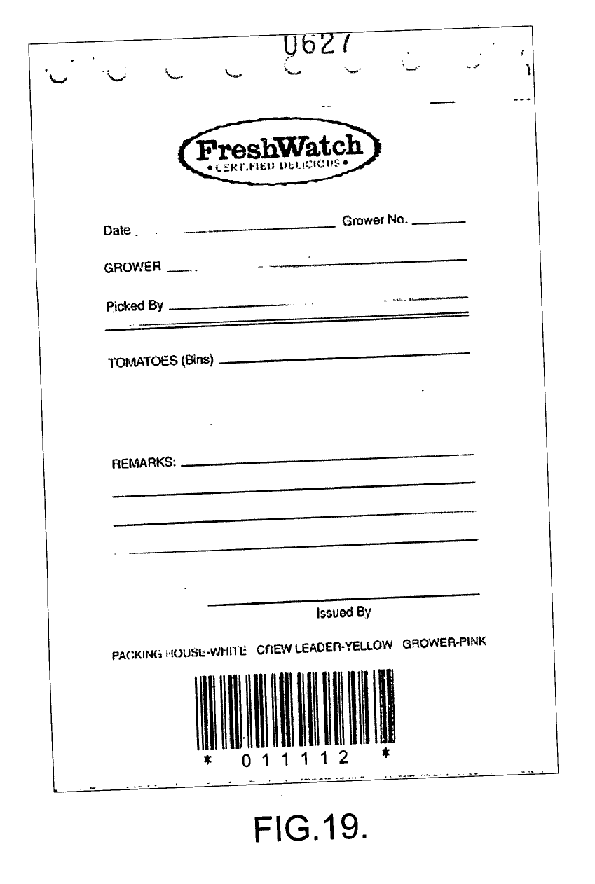

Referring to FIGS. 1 & 6, the determination is made as to which Harvest Zone is to be harvested based on crop selection criteria. A mobile computer (3.1) or other device is utilized to capture relevant information about all truck-loads of product that originate from that Harvest Zone during that specific harvest event assigning each a discrete Load ID (FIG. 1.3). The user will utilize the Harvest Module software (FIGS. 13.2-13.4) to scan (or alternatively generate) the Load ID of the Field Ticket (FIGS. 19 and 1.3), record the Farm, Field, sub-Field, Load ID, Date/Time, Quantity, and Crew Leader. The user repeats this procedure for each Load ID associated with that harvest event. The mobile computer allows the user to review, edit, or delete individual Load IDs before downloading the to the data warehouse (FIG. 3.1).

Uploading Harvest Data

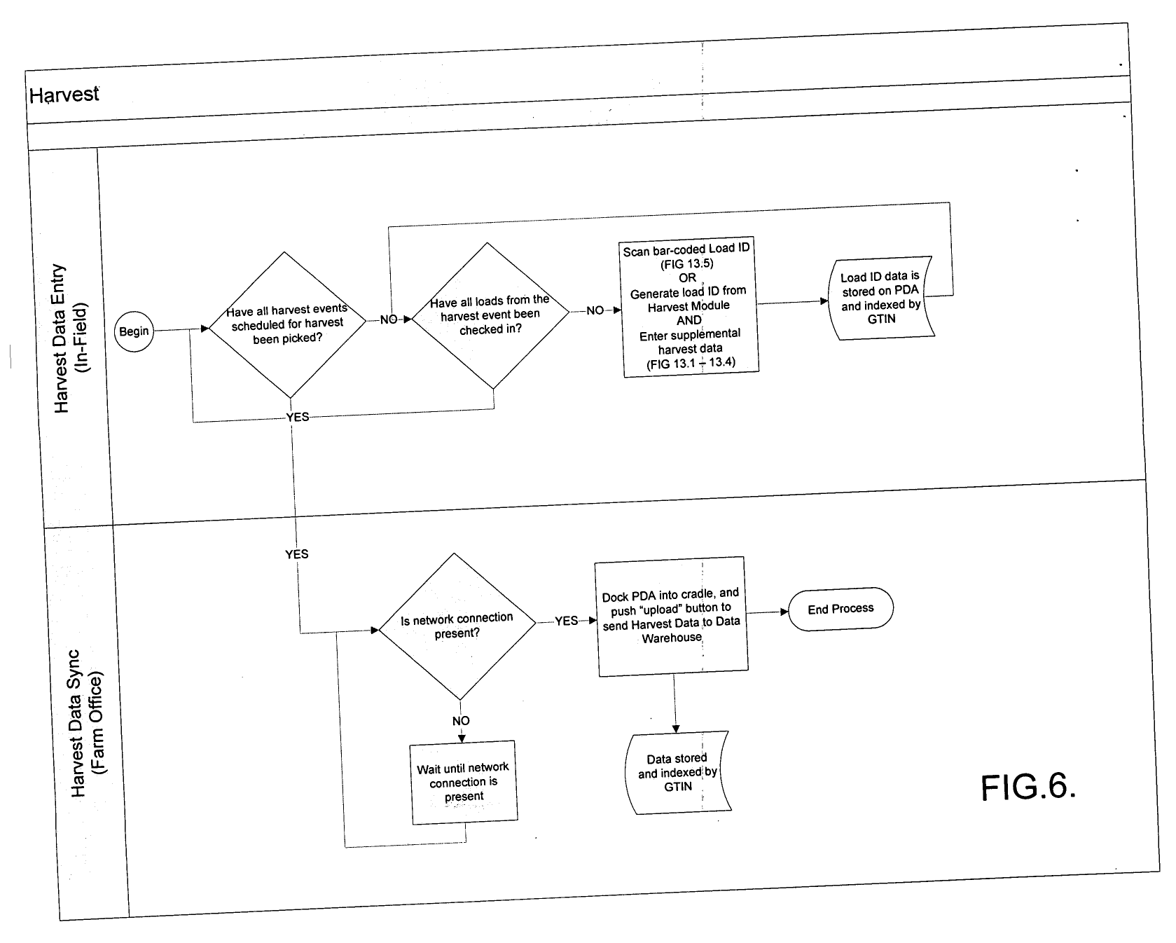

Referring again to FIG. 6, after all harvest events (and their corresponding Load IDs) have been entered, the user can choose to upload the harvest event information to the data warehouse (FIG. 3.6) for storage/management/publishing. By returning the mobile computer (FIG. 3.1) to its' docking cradle where the unit is recharged and, if an internet connection is available, the user can optionally upload the current harvest event data to the data warehouse (FIG. 3.6), where the data is indexed by GTIN for future reference. In one embodiment, all harvest event data is erased from the mobile computer to allow following upload. If the user chooses NOT to upload, the current harvest event data remains on the mobile computer and no records are sent to the data warehouse.

Crop Receiving

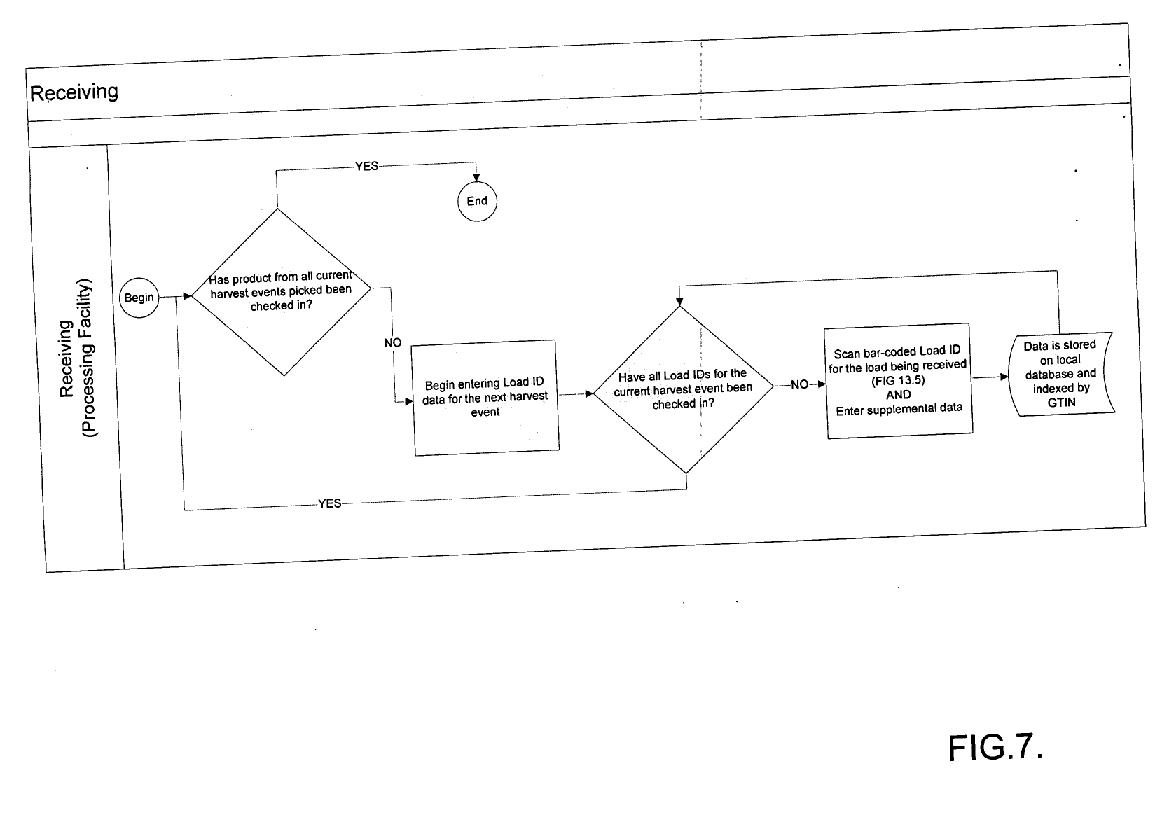

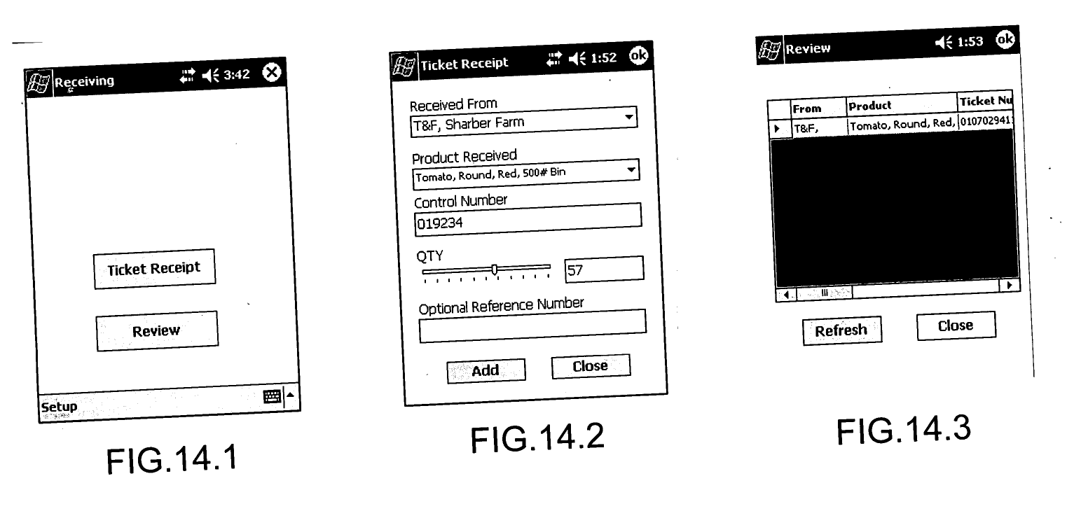

Referring to FIG. 7, as product arrives from the field, a Load ID (FIG. 1.3) is required of the truck operator before the product will be received by the processing operations staff. The Load ID is scanned either using a tethered scanner attached to a networked personal computer running QMS (FIG. 14-14.3), a mobile computer, or other device running QMS software (FIG. 14.1-14.3). After scanning the Load ID, the user identifies the Harvest Zone (FIG. 1.4) from which the Load ID originated, the quantity being received, the product that being received, and optional external reference information (foreign key data for optional system integration activities) for that Load ID. This method of the invention is duplicative relative to the process noted in “Capturing Harvest Data”. The system and method of the present invention, therefore, allows harvesting operations to operate on a chronologically independent basis relative to processing operations and provides the flexibility needed for practical implementation of the system in commercial environments. As Load IDs are scanned, product is stored discretely by Harvest Zone until processing can commence. When all Load IDs have been checked in to the system, the user can review the sum total of all Load IDs that comprise that Harvest Zone, make changes/corrections, and commit the data to the Local Data Store (FIG. 3.5).

When product is being Received from a Shed Operation by a Repack Operation, all process steps remain the same. The only difference is in the artifact driving the process. In a Shed Operation, Load IDs in the form of Field Tickets are used to drive the check-in process. In a Repack Operation Processor IDs in the form of GTIN bar-coded case labels drive the check-in. Each different operations, such as shed, repacker, or shipping operation is also referred to herein as a “processing location” or “processing operation.”

Crop Processing

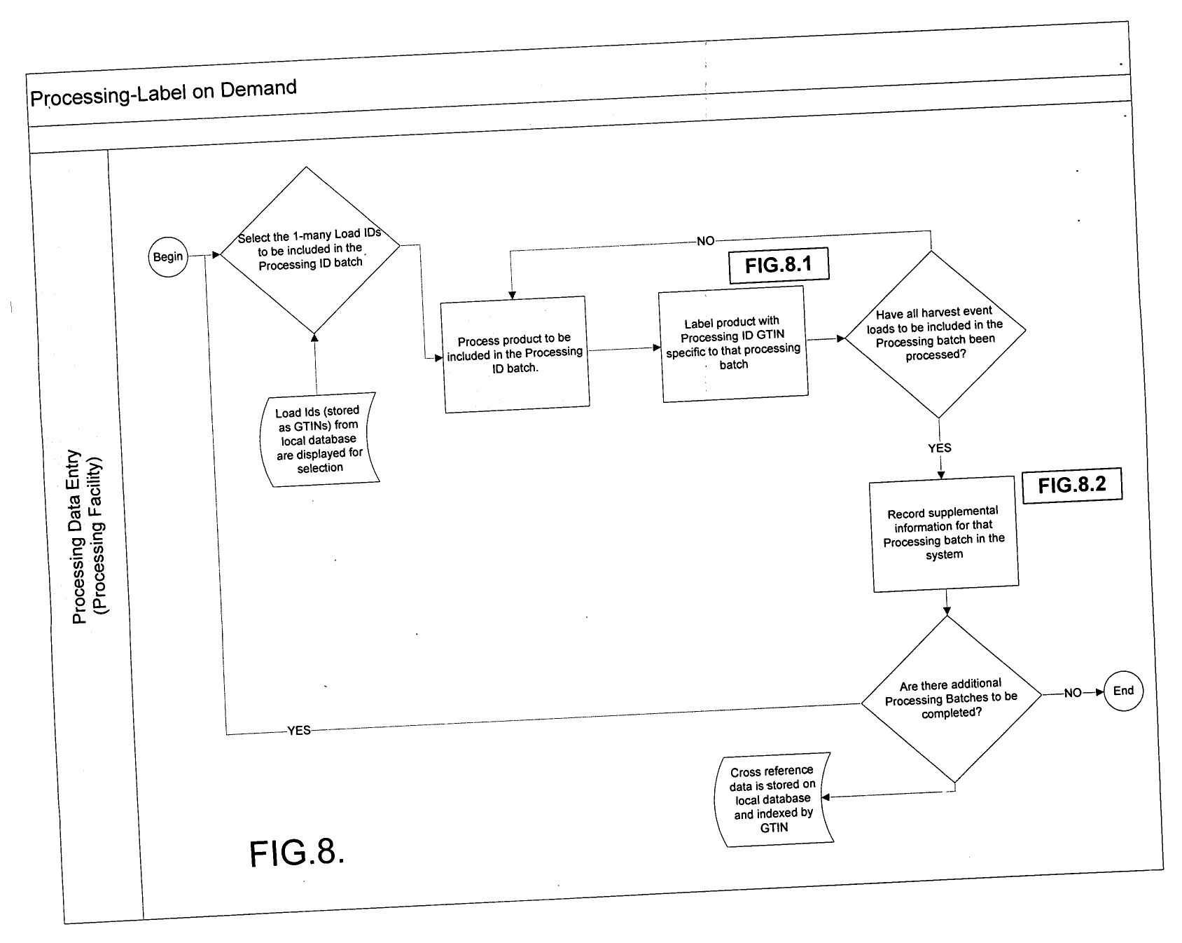

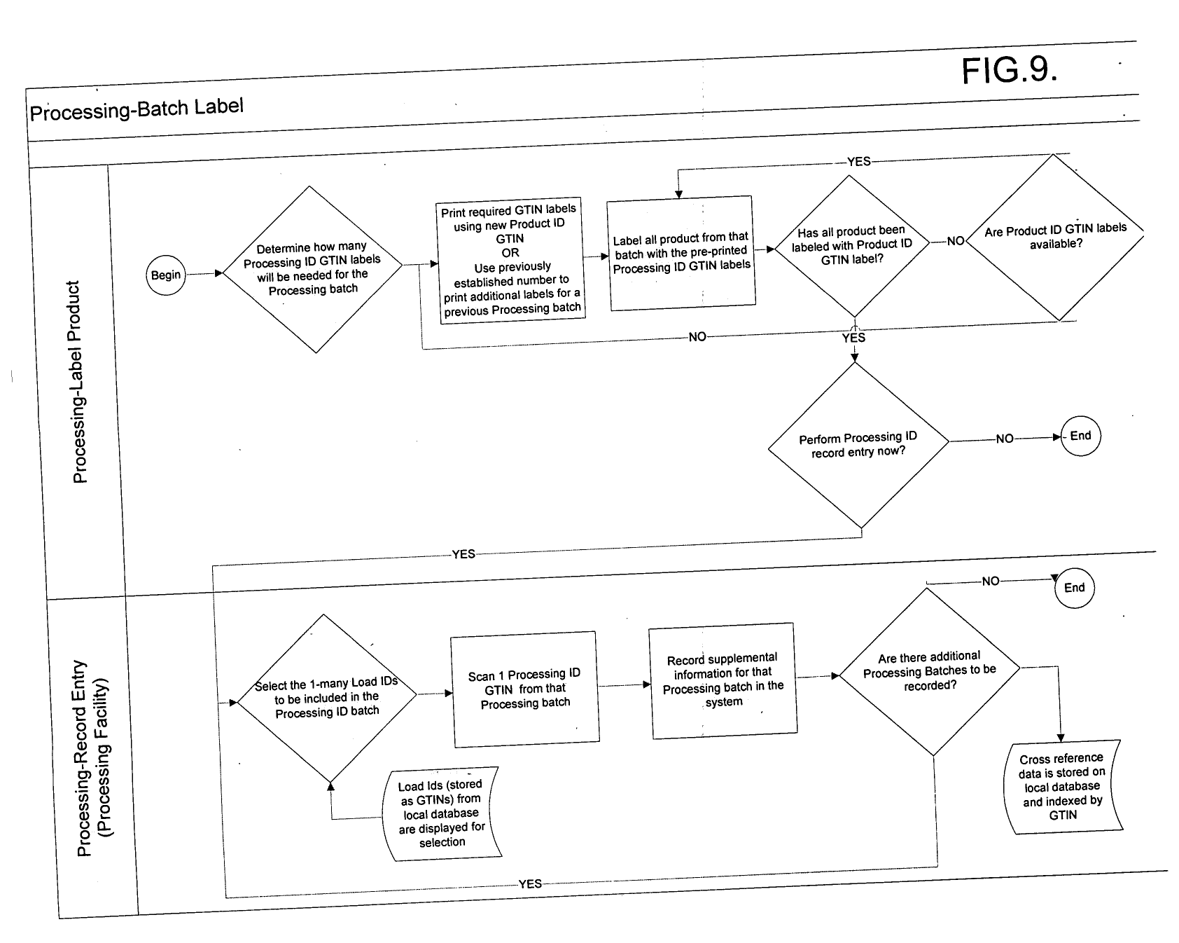

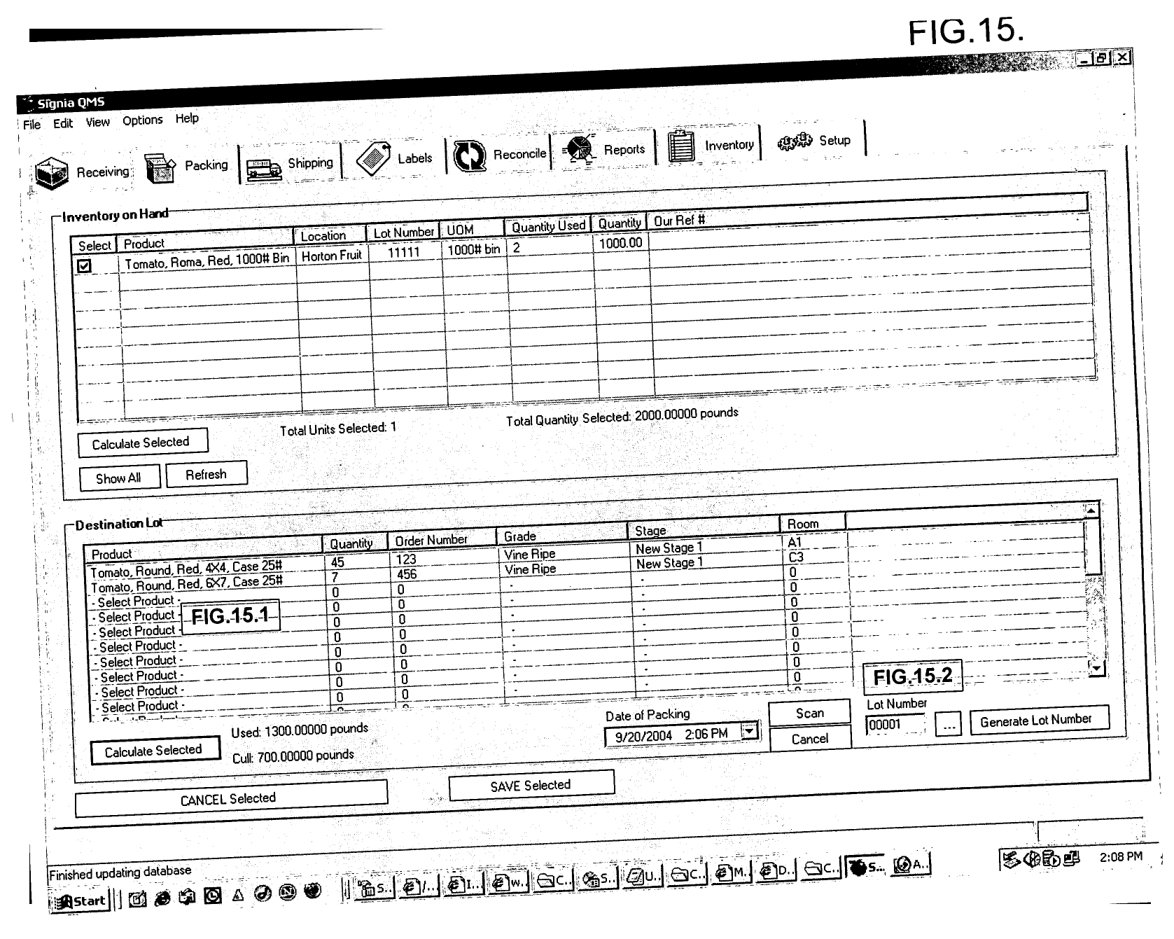

Referring now to FIG. 8, prior to processing, the shed operations user determines the Harvest Zone(s) (FIG. 1.4) to be utilized in the Processing Batch. The user will then select all of the Load IDs (FIG. 1.3) associated with the Harvest Zones to be processed from the “Inventory On Hand” section of the “Packing Screen” (FIG. 15.), recording the corresponding output configuration in the “Destination Lot” section of the same screen as product is generated by the processing line. Output configuration is simply the product that is generated during a processing batch. For example, taking 300 incoming 25 pound boxes of tomatoes and re-configure 50% of them into 4-packs of tomatoes in a clamshell and repack the other 50% into bulk 15 pound cases of tomatoes used to sell one tomato at a time. The output configuration of that processing batch is X numbers of clamshells and Y cases of bulk 15 pounders.

In the course of selecting the product that is being created (FIG. 15.1), the system combines this product ID with the GLN of the processing facility (FIG. 20.1) and the Processing ID (FIG. 15.2) to create a new GTIN (FIG. 1.2). As this is a shed-packed processing example, it should be noted that the user will use the “Generate Lot Number” function to assign a Processing ID in real-time as the processing batch is processed. Once all marketable product has been processed and recorded in the “Destination Lot” section, the entire processing record can be revised, edited, and then committed to the Local Data Store (FIG. 3.5).

Crop Labeling

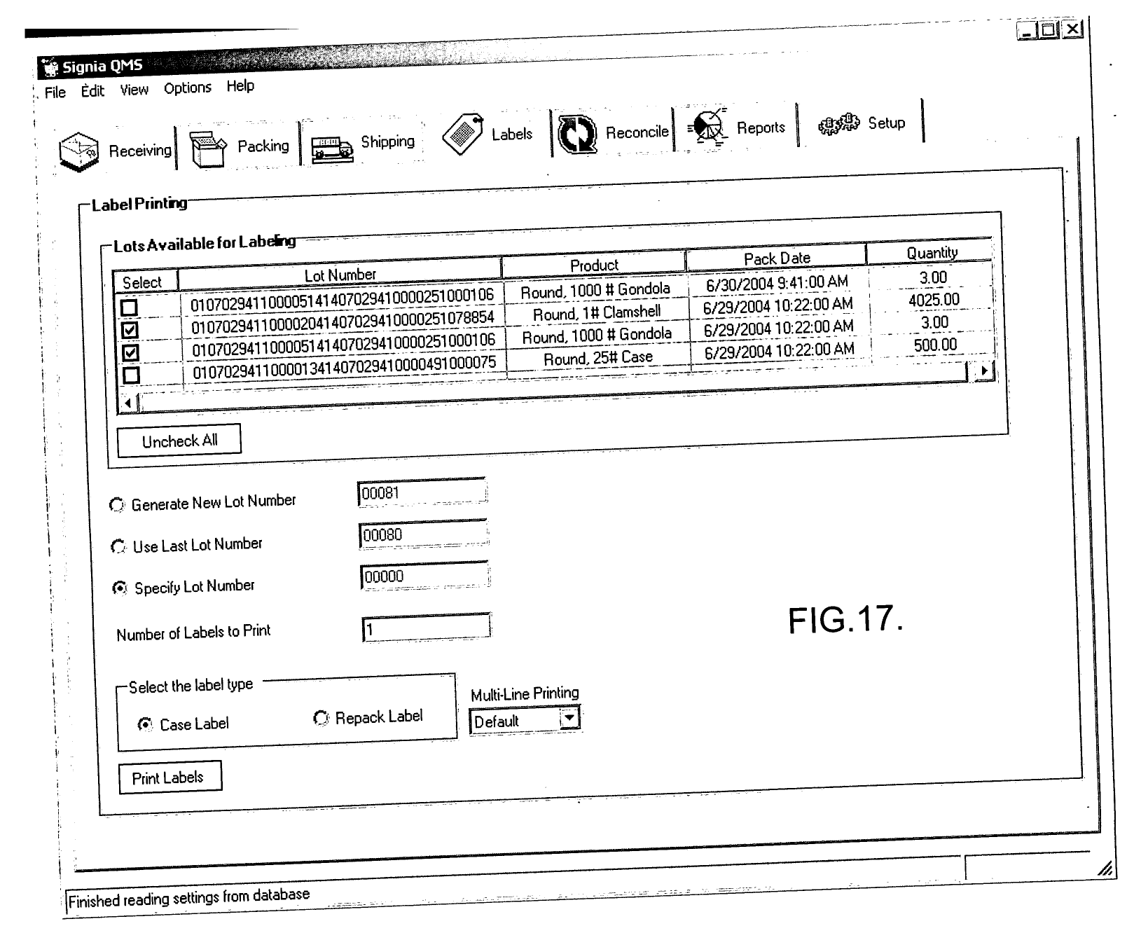

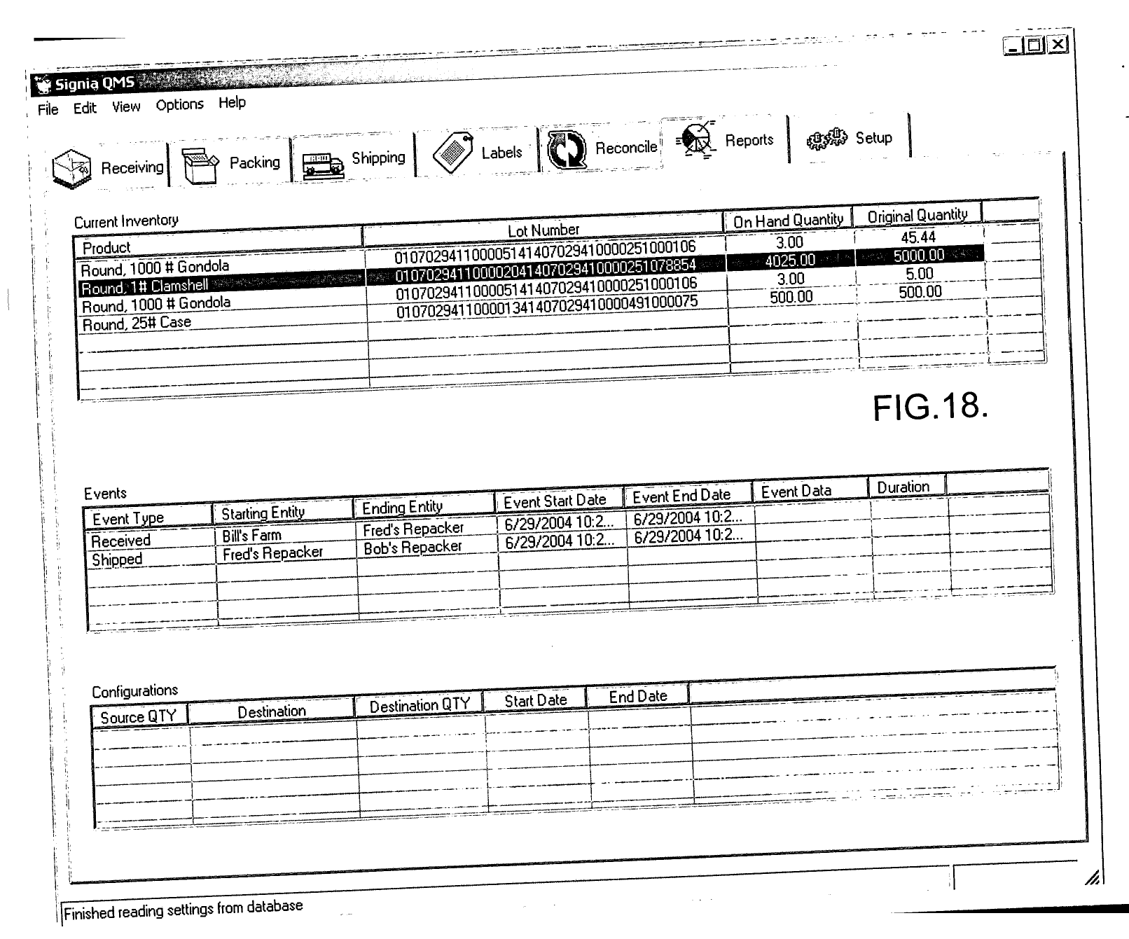

Referring to FIG. 17, when print-and-apply printing technology is present, the user can send print jobs, such as printing GTIN Barcodes, to each of the processing lines (FIG. 8.1) by using the “Label Printing” function.

Shipping

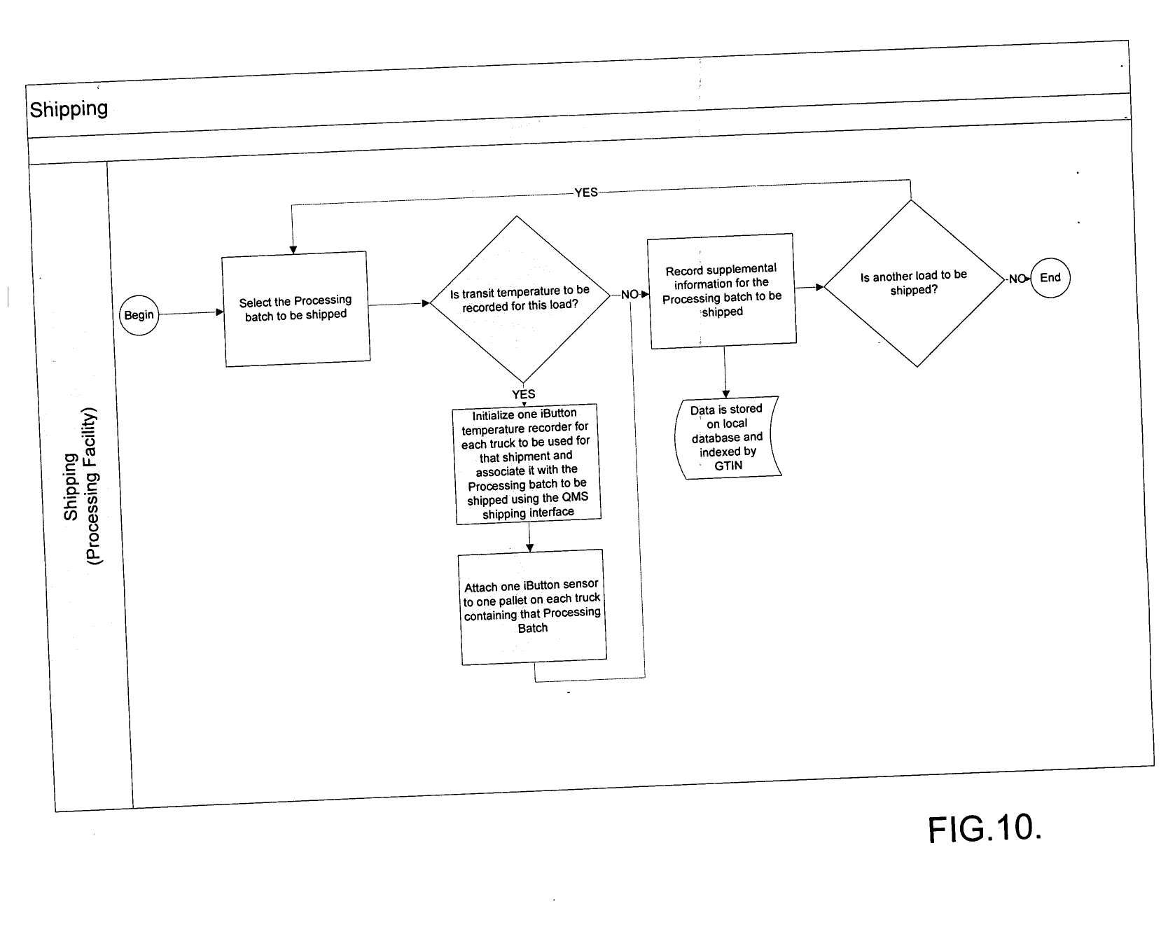

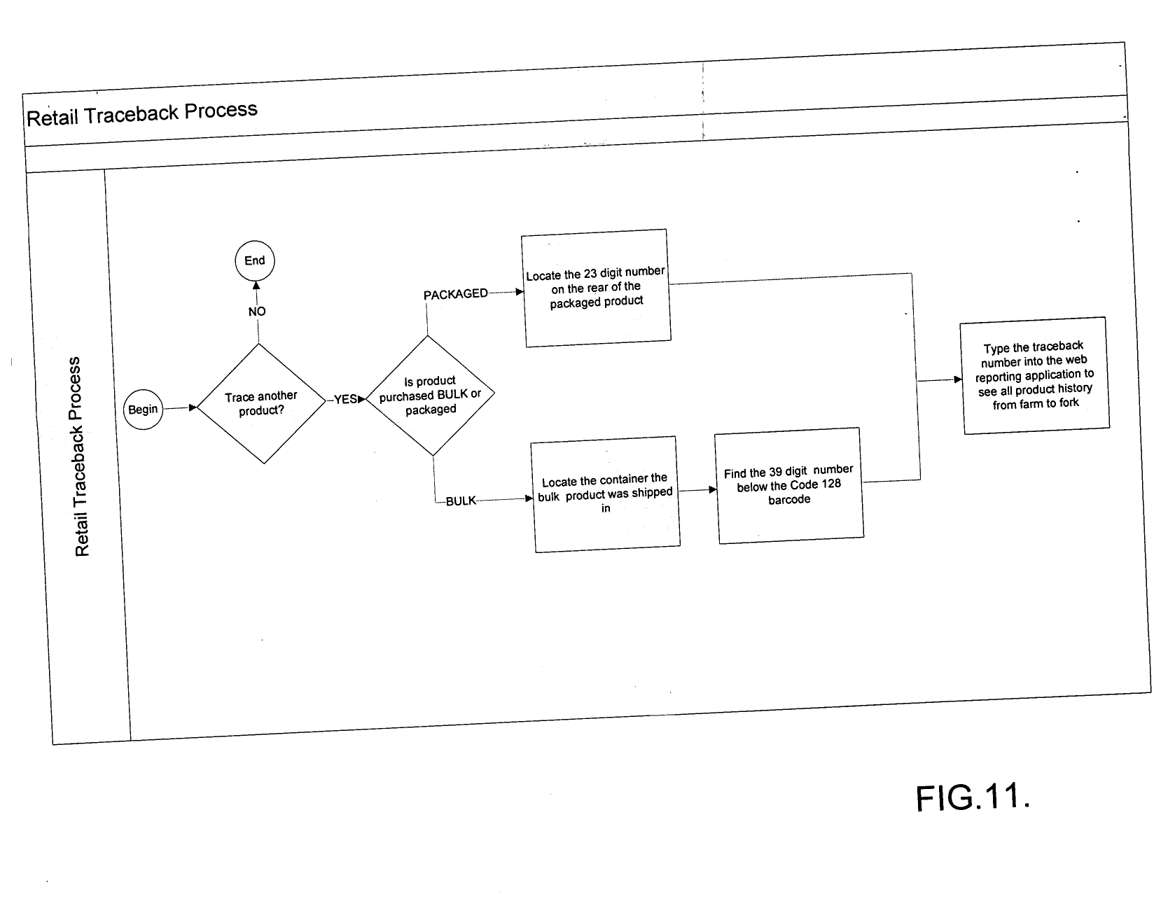

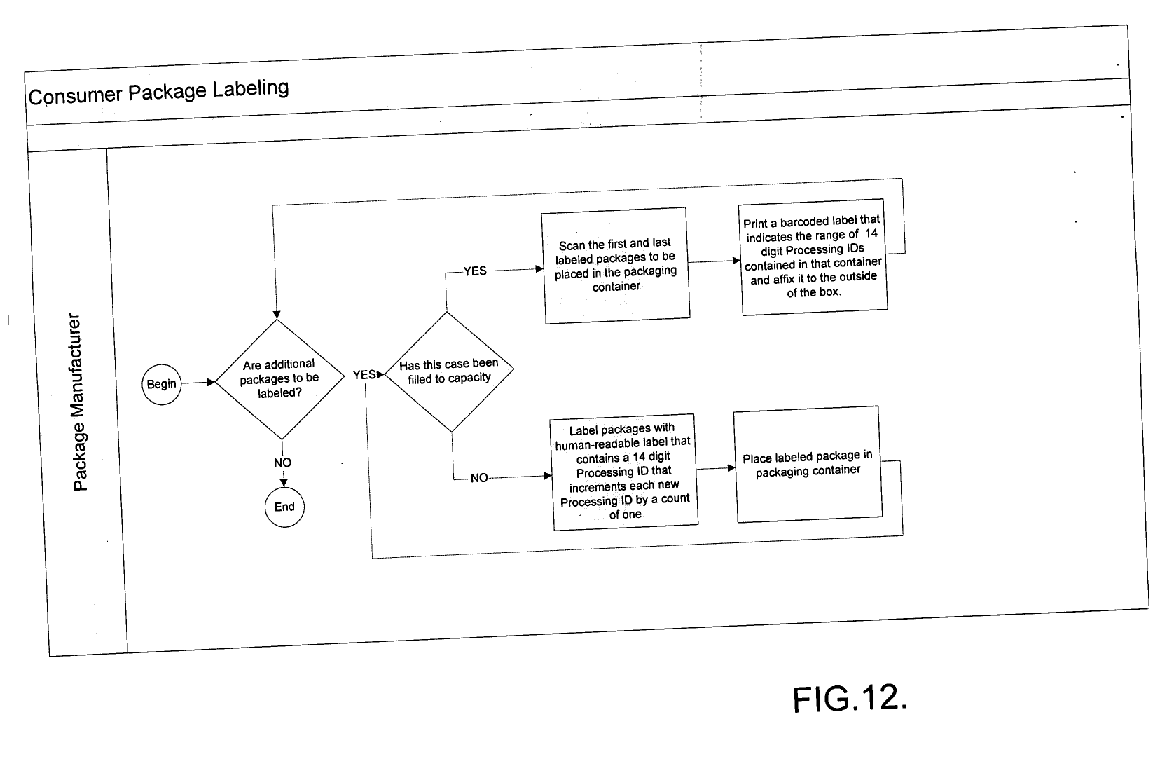

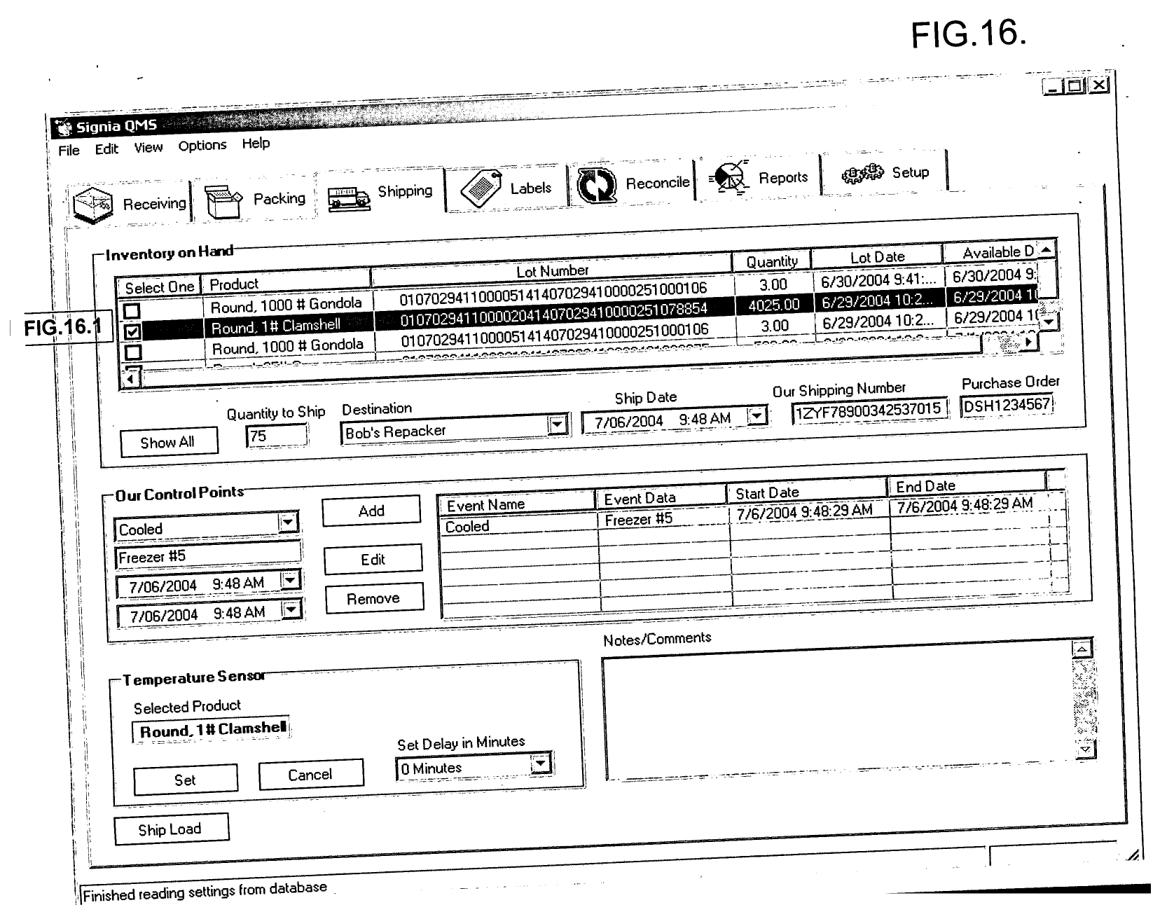

Referring to FIG. 10, when the time comes to ship products tracked within the QMS system, the user will select the Processing IDs to be shipped from the “Inventory on Hand” section (FIG. 16) of the “Shipping” screen (FIG. 16.1), and enter the quantity to be shipped, destination, date, and customer PO number (optional). Additionally, if the user has defined Control Points within the QMS Setup (FIG. 20.2), the user can capture that information within the “Shipping” screen prior to committing the shipment to the Local Data Store (FIG. 3.5).

### EXAMPLE VI

### Field Packed and Labeled Product Direct From Field

Crop Labeling

The user prints the quantity of Processing ID “Case Labels” needed for the harvest event in advance using the “Label Printing” function (FIG. 17.) in conjunction with a batch printing device. In this model, the product GTIN (FIG. 1.2) is established in advance of actual packing activities because the product id, processing location, and Processing ID are established at the point in time that the labels are actually printed

Capturing Harvest Data

Referring to FIG. 6, the determination is made as to which Harvest Zone is to be harvested based on crop selection criteria. Product is harvested, placed into cases, and the cases are labeled in the field using the GTIN labels printed for that Processing ID. The user will utilize the Harvest Module software (FIGS. 13.2-13.4) to scan one of the pre-printed GTIN labels and record the Farm, Field, sub-Field, Load ID, Date/Time, Quantity, and Crew Leader. The user may then review, edit, or delete individual Load IDs before closing that harvest event data entry.

Uploading Harvest Data

Referring to FIG. 6, after all harvest events (and their corresponding Load IDs) have been entered, the user can choose to upload the harvest event information to the data warehouse for storage/management/publishing. By returning the mobile computer to its docking cradle, where the unit is recharged and, the user can optionally upload the current harvest event data to the data warehouse (FIG. 3.6), where the data is indexed by GTIN for future reference. In one embodiment, all harvest event data is erased from the mobile computer to allow following upload. If the user chooses NOT to upload, the current harvest event data remains on the mobile computer and no records are sent to the data warehouse.

Shipping

Referring to FIG. 10, when the time comes to ship products tracked within the QMS system, the user will select the Processing IDs to be shipped from the “Inventory on Hand” section (FIG. 16) of the “Shipping” screen (FIG. 16.1), and enter the quantity to be shipped, destination, date, and customer PO number (optional). Additionally, if the user has defined Control Points within the QMS Setup (FIG. 20.2), the user can capture that information within the “Shipping” screen prior to committing the shipment to the Local Data Store (FIG. 3.5).

### EXAMPLE VII

### Product Packed into Consumer Containers in the Field

Product that is field packed into consumer units of measure presents unique challenges to implementing item level traceability. Consumer units of measure are smaller than bulk configurations and when this small package size is combined with a fast-paced harvesting process, there is not sufficient time to label each container with a harvest event specific Processing ID either during or after packing.

Referring to FIG. 40, the present invention provides a system and method for assigning a Processing ID to product field-packed into consumer containers at the time the packaging is manufactured. Specifically, the Processing ID label is applied immediately following the application of the brand/UPC label. The Processing ID applied to consumer container increments by one for each label created. For example, the first container might get a Processing ID ending in 100, the next would end in 101, the next would get 102, etc. As containers are created and labeled, they are placed into a case for shipping to customer. After a case is filled with the appropriate number of individual containers, the range of numbers used to identify the containers in that case is captured and printed out in a bar-coded format on the outside of the case. For example, in a case that holds 300 containers, the bar-coded range label on the outside of the container might contain a range of Processing IDs spanning 101 to 401. It does not matter if Processing ID labels are concurrent as long as the range itself is captured.

Referring to FIG. 50, according to the present invention, when the operation decides to pick a particular Harvest Zone, the approximate number of cases of consumer containers is sent into the field. As cases are opened for utilization, the operational supervisor scans the Processing ID range bar-code on the case with a mobile computer, identifies the Harvest Zone being picked, and enters other supplementary information about the harvested product. The scans associate the range of Processing IDs contained on the individual consumer packages to the Harvest Zone being picked and corresponding production history. The picking crew then removes the consumer containers from the case and picks the product into the containers in the field, placing filled containers on a flat which is later palletized for shipping to the customer.

The foregoing description of the embodiments of the present system and method of the present invention have been provided for the purposes of illustration and description. Many modifications and variations with regard will be apparent to those skilled in the art, including hardware setup, information storage, timing of information recording, labeling, etc. The embodiments were chosen in order not to limit the scope of the invention, but to explain the principles of the invention and its practical applications.

1) A computer implemented method for the monitoring and control of a batch of fresh produce as it moves through a supply chain comprising the steps of:
a) assigning a non-unique product identifier to said batch of fresh produce;
b) associating a global location identifier indicating a point of origin of said batch with said non-unique product identifier, thereby transforming said non-unique product identifier into a globally unique identifier for said batch of fresh produce;
c) identifying a process location within a supply chain with a global geo-referenced identifier that is incorporated into said globally unique identifier;
d) capturing modification information of said batch relative to said location; and
e) associating said modification information with said globally unique identifier.

2) A computer implemented method for the monitoring and control of a batch of fresh produce according to claim 1 further comprising the step of providing a supply chain history of said batch.
